(19) United States
(12) Patent Application Publication
(10) Pub. No.: US 2023/0042599 A1
(43) Pub. Date: Feb. 9, 2023

(54) CELLULOSIC COMPOUNDS AND AGRICULTURAL USES THEREOF

(71) Applicant: HELIAE DEVELOPMENT, LLC, Gilbert, AZ (US)

(72) Inventors: Taner Bicer, Gilbert, AZ (US); Chiliang Chen, Ames, IA (US); Erik Velkme, Tempe, AZ (US); Yan Xu, Tempe, AZ (US)

(21) Appl. No.: 17/816,936

(22) Filed: Aug. 2, 2022

Related U.S. Application Data
(60) Provisional application No. 63/228,597, filed on Aug. 2, 2021.

(51) Int. Cl. A01N 63/20; A01N 25/10; A01N 25/34; A01P 21/00

(52) U.S. Cl. CPC A01N 63/20; A01N 25/10; A01N 25/34; A01P 21/00

(57) ABSTRACT

The present disclosure relates to an agricultural composition comprising: a) plant growth promoting Gram-negative bacteria; b) a desiccation protectant selected from the group consisting of: a carboxyalkylcellulose or derivative or salt thereof, a hydroxyalkylcellulose or derivative or salt thereof, an alginate or derivative or salt thereof, trehalose or a derivative or salt thereof; tamarind seed gum, locust bean gum, xanthan gum, tara gum, guar gum, pectin, pullulan, psyllium seed gum, and carrageenan; and combinations thereof; and c) an agriculturally acceptable carrier. The disclosure also provides a method of increasing resistance to desiccation in plant growth promoting Gram-negative bacteria, the method comprising adding a desiccation protectant to the plant growth promoting Gram-negative bacteria.

### CROSS REFERENCE TO RELATED APPLICATIONS

This application claims priority to U.S. Provisional Patent Application No. 63/228,597, filed Aug. 2, 2021, entitled CELLULOSIC COMPOUNDS AND AGRICULTURAL USES THEREOF, the entire content of which is hereby incorporated by reference herein.

### TECHNICAL FIELD

The present invention relates to agricultural compositions comprising a plant growth promoting Gram-negative bacteria and a desiccation protectant to help preserve the viability of the bacteria.

### BACKGROUND

Various microorganisms are known to have a beneficial effect on plants. These microorganisms include bacteria of the genera Rhizobium, Bradyrhizobium, Pseudomonas, Serratia, Azotobacter, Enterobacter, Azospirillum, and Methylobacterium. Such microorganisms can be introduced to the plants by the use of inoculant compositions. The process by which inoculant compositions are created includes the step of fermenting the microorganisms, generally on a nutrient medium.

The inoculant compositions can be applied directly onto seeds of plants or can be applied in furrow immediately prior to the seeds being planted. Inoculation of the seeds or soil with beneficial microorganisms for crop improvement has been practiced for a number of years. However, variable and inconsistent results have often been observed, possibly due to loss of inoculant viability or variability of dosage due to changes in inoculant viability.

When an inoculant is applied at the time of sowing, whether in furrow application or by on-seed application, the microorganisms in the inoculant do not have time to adjust to the new environment. Consequently, the microorganisms in the inoculant may have a low rate of survival.

Currently, to improve viability of the microorganisms in the inoculant, extenders based on sugars or polymers are added when the inoculant is added to the seed, or at the time of sowing. Because the extenders are added after packaging of the inoculant, the extenders have no effect on the survival and stability of the inoculant in pack.

Also, the addition of extenders at the time the inoculant is added to the seed or at the time of sowing is cumbersome and generally must be performed by the end-users of the inoculant (e.g., farmers) in a non-controlled environment (e.g., in a barn or in a farm field). Thus, there is an increased likelihood that the extenders will be improperly applied.

To overcome the problems associated with adding extenders after the inoculant is prepared, extenders have also been added to the nutrient medium prior to the fermentation step of creating the liquid inoculant. However, addition of the extenders at an optimal level for on-seed survival before fermentation inhibits growth of the microorganisms.

Therefore, there is a need for compositions and a method for increasing survival and stability of a microorganism (e.g., bacteria) of a liquid inoculant during storage, and for improving on-seed survival and stability of a microorganism of a liquid inoculant once placed on a seed.

### SUMMARY

The present disclosure relates to an agricultural composition comprising: a) plant growth promoting Gram-negative bacteria; b) a desiccation protectant selected from the group consisting of: a carboxyalkylcellulose or derivative or salt thereof, a hydroxyalkylcellulose or derivative or salt thereof, an alginate or derivative or salt thereof, trehalose or a derivative or salt thereof tamarind seed gum, locust bean gum, xanthan gum, tara gum, guar gum, pectin, pullulan, psyllium seed gum, and carrageenan; and combinations thereof; and c) an agriculturally acceptable carrier.

In some aspects, the carboxyalkylcellulose or derivative thereof is selected from the group consisting of: carboxymethylcellulose, hydroxyethylcarboxymethylcellulose, hydroxypropylcarboxymethylcellulose, methoxyethylcarboxymethylcellulose, ethoxyethylcarboxymethylcellulose, diethylaminocarboxymethylcellulose, and combinations thereof.

In other aspects, the hydroxyalkylcellulose or derivative thereof is selected from the group consisting of: hydroxymethylcellulose, hydroxyethylcellulose, hydroxyethyl methyl cellulose, hydroxypropylcellulose, hydroxybutylcellulose, hydroxypropyl methyl cellulose, methylhydroxyethylcellulose, methylhydroxypropylcellulose, ethyl hydroxyethyl cellulose, carboxymethylhydroxyethylcellulose, and combinations thereof.

In other aspects, the alginate or derivative thereof is selected from the group consisting of: alginic acid, sodium alginate, ammonium alginate, calcium alginate, magnesium alginate, propylene glycol alginate, and combinations thereof.

In one aspects, the trehalose or derivative thereof is trehalose or trehalose choline chloride (TCH).

In some aspects, the plant growth promoting Gram-negative bacteria belong to a genus selected from the group consisting of Pseudomonas, Burkholderia, Stenotrophomonas, Rhizobium, Bradyrhizobium, Sinorhizobium, Azospirillum, Herbaspirillum, Lysobacter, Pantoea, Azotobacter, Enterobacter, Klebsiella, Kosakonia, Rahnella, Sphingomonas, Massilia, Gluconacetobacter, Acetobacter, Asaia, Komagataeibacter, Nguyenibacter, Swaminathania, Janthinobacterium, Duganella, Methylobacterium, Flavobacterium, Serratia, Variovorax, and combinations thereof.

In one aspect, the plant growth promoting Gram-negative bacteria are present in the agricultural composition as an isolated biologically pure culture.

In other aspects, the agricultural composition further comprises extracellular polymeric substance (EPS), biomass, or a combination thereof produced by microalgae. In one aspect, the biomass is a whole broth culture or a cell pellet of the microalgae.

In one aspect, the microalgae are green algae in the order Chlorellales. In another aspect, the green algae belong to a genus selected from the group consisting of Acanthosphaera, Actinastrum, Apatococcus, Apodococcus, Auxenochlorella, Catena, Chlorella, Chloroparva, Closteriopsis, Compactochlorella, Coronastrum, Cylindrocelis, Diacanthos, Dicellula, Dicloster, Dictyosphaerium, Didymogenes, Dunaliella, Fissuricella, Follicularia, Geminella, Gloeotila, Golenkiniopsis, Hegewaldia, Helicosporidium, Heynigia, Hindakia, Hormospora, Kalenjinia, Keratococcus, Leptochlorella, Marasphaerium, Marinichlorella, Marvania, Masaia, Meyerella, Micractinium, Mucidosphaerium, Muriella, Nannochloris, Nanochlorum, Palmellochaete, Parachlorella, Planktochlorella, Podohedra, Prototheca, Pseudochloris, Pseudosiderocelopsis, Pumiliosphaera, Scenedesmus, Siderocelis, and Zoochlorella.

In some aspects, the green algae belong to the genus Parachlorella. In another aspect, the green algae are Parachlorella kessleri. In one aspect, the green algae are Parachlorella kessleri Accession No. NCMA 202103001.

In other aspects, the microalgae are red algae in the phylum Rhodophyta. In one aspect, the red algae belong to a genus selected from the group consisting of Acanthopeltis, Campylaephora, Ceramium, Chondrus, Hypnea, Galdieria, Gelidium, Gigartina, Gloiopeltis, Gracilaria, Grateloupia, Pachymeniopsis, Porphyra, Porphyridium, Pterocladia, and Rhodella. In one aspect, the red algae belong to the genus Porphyridium. In another aspect, the red algae are Porphyridium cruentum.

In some aspects, the extracellular polymeric substance comprises an exopolysaccharide. In other aspects, the exopolysaccharide has a molecular weight of between about 100 kD and about 150 kD; at least 50% of the monosaccharides in the e exopolysaccharide are galactose; the extracellular polymeric substance has a viscosity of between about 130000 mPa·s and about 150000 mPa·s at a shear rate of 1 s⁻¹ and/or a viscosity of between about 40 mPa·s and about 60 mPa·s at a shear rate of 1000 s⁻¹; the extracellular polymeric substance has a zero shear viscosity of between about 400000 mPa·s and about 440000 mPa·s; and/or the extracellular polymeric substance has a complex modulus plateau of between about 20 Pa and about 50 Pa and/or a phase angle plateau of between about 20° and about 30°.

In some aspects, the agricultural composition is formulated as a seed treatment. In other aspects, the agricultural composition is formulated for foliar application or in-furrow application.

In one aspect, the present disclosure relates to a plant propagation material treated with an agricultural composition described herein.

In other aspects, the present disclosure provides an agricultural composition comprising: a) plant growth promoting Gram-negative bacteria; b) a carboxyalkylcellulose or derivative thereof selected from the group consisting of: carboxymethylcellulose, hydroxyethylcarboxymethylcellulose, hydroxypropylcarboxymethylcellulose, methoxyethylcarboxymethylcellulose, ethoxyethylcarboxymethylcellulose, diethylaminocarboxymethylcellulose, and combinations thereof; and c) an agriculturally acceptable carrier. In one aspect, the carboxyalkylcellulose or derivative thereof is carboxymethylcellulose.

In some aspects, the present disclosure relates to a method of increasing resistance to desiccation in plant growth promoting Gram-negative bacteria, the method comprising adding a desiccation protectant to the plant growth promoting Gram-negative bacteria, wherein the desiccation protectant is selected from the group consisting of: a carboxyalkylcellulose or derivative or salt thereof, a hydroxyalkylcellulose or derivative or salt thereof, an alginate or derivative or salt thereof, trehalose or a derivative or salt thereof; tamarind seed gum, locust bean gum, xanthan gum, tara gum, guar gum, pectin, pullulan, psyllium seed gum, and carrageenan; and combinations thereof.

In one aspect, the method further comprises adding to the plant growth promoting Gram-negative bacteria an extracellular polymeric substance (EPS), biomass, or a combination thereof produced by microalgae.

### BRIEF DESCRIPTION OF THE DRAWINGS

FIGS. 1A and 1B depict the average colony forming units (CFU) on a log scale of cultured Kosakonia sp. cells recovered after being treated with water (untreated control or “UTC”), trehalose, carboxymethylcellulose (“CMC”), methylcellulose (“MC”), extracellular polymeric substance from Parachlorella kessleri Accession No. NCMA 202103001 (“EPS”), sodium alginate (“Na-Alginate”), Parachlorella kessleri Accession No. NCMA 202103001 whole broth (“3001 Broth”), or Parachlorella kessleri Accession No. NCMA 202103001 cell pellet after centrifugation (“3001 Pellet”) after 5 days of desiccation stress. FIG. 1A depicts the results when the protectants were added undiluted (i.e., at 1× dilution) for whole broth and cell pellets or at a concentration of 1% (i.e., 1 g/100 mL) for all other protectants, while FIG. 1B depicts the results when the protectants were added at a dilution of 2× (i.e., at 2 parts water to 1 part protectant) for whole broth and cell pellets or at a concentration of 0.5% (i.e., 0.5 g/100 mL) for all other protectants.

FIGS. 2A, 2B, and 2C depict representative plates containing Kosakonia sp. cell colonies recovered after being diluted at various dilutions after 5 days of desiccation stress that were used to determine the values presented in FIGS. 1A and 1B.

FIGS. 3A and 3B depict the average colony forming units (CFU) on a log scale of cultured Kosakonia sp. cells recovered after being treated with water (untreated control or “UTC”), trehalose, carboxymethylcellulose (“CMC”), methylcellulose (“MC”), extracellular polymeric substance from Parachlorella kessleri Accession No. NCMA 202103001 (“EPS”), sodium alginate (“Na-Alginate”), Parachlorella kessleri Accession No. NCMA 202103001 whole broth (“3001 Broth”), or Parachlorella kessleri Accession No. NCMA 202103001 cell pellet after centrifugation (“3001 Pellet”) after 7 days of desiccation stress. FIG. 3A depicts the results when the protectants were added undiluted (i.e., at 1× dilution) for whole broth and cell pellets or at a concentration of 1% (i.e., 1 g/100 mL) for all other protectants, while FIG. 3B depicts the results when the protectants were added at a dilution of 2× (i.e., at 2 parts water to 1 part protectant) for whole broth and cell pellets or at a concentration of 0.5% (i.e., 0.5 g/100 mL) for all other protectants.

FIGS. 4A, 4B, and 4C depict representative plates containing Kosakonia sp. cell colonies recovered after being diluted at various dilutions after 7 days of desiccation stress that were used to determine the values presented in FIGS. 3A and 3B.

FIG. 5 depicts representative larger agar plates containing Kosakonia sp. cells recovered after being treated with water (untreated control or “UTC”), trehalose, carboxymethylcellulose (“CMC”), methylcellulose (“MC”), extracellular polymeric substance from Parachlorella kessleri Accession No. NCMA 202103001 (“EPS”), sodium alginate (“Na-Alginate”), Parachlorella kessleri Accession No. NCMA 202103001 whole broth (“3001 Broth”), or Parachlorella kessleri Accession No. NCMA 202103001 cell pellet after centrifugation (“3001 Pellet”) after 7 days of desiccation stress. These plates were used to confirm the results presented in FIGS. 3A and 3B.

FIGS. 6A, 6B, and 6C depict the average colony forming units (CFU) on a log scale of co-cultured Kosakonia pseudosacchari strain JM-387 and Pseudomonas aylmerense strain S1E40 cells recovered after being treated with water (untreated control or “UTC”), trehalose, carboxymethylcellulose (“CMC”), methylcellulose (“MC”), extracellular polymeric substance from Parachlorella kessleri Accession No. NCMA 202103001 (“EPS”), sodium alginate (“Na-Alginate”), Parachlorella kessleri Accession No. NCMA 202103001 whole broth (“3001 Broth”), or Parachlorella kessleri Accession No. NCMA 202103001 cell pellet after centrifugation (“3001 Pellet”) after 3 days, 5 days, and 7 days of desiccation stress, respectively. The protectants were added undiluted (i.e., at 1× dilution) for whole broth and cell pellets or at a concentration of 1% (i.e., 1 g/100 mL) for all other protectants.

### DETAILED DESCRIPTION

As used herein and in the appended claims, the singular forms “a,” “an,” and “the” include plural referents unless the context clearly dictates otherwise. For example, “a” or “an” means “at least one” or “one or more.”

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

The term “microalgae” as used herein refers to microscopic single cell organisms such as microalgae, cyanobacteria, algae, diatoms, dinoflagellates, freshwater organisms, marine organisms, or other similar single cell organisms capable of growth in phototrophic, mixotrophic, or heterotrophic culture conditions.

The term “biomass” as used herein refers to the mass of biological materials produced by living organisms (e.g., algae, bacteria, etc.). The biomass includes, but is not limited to, living and dead cells and biological compounds produced by the cells including carbohydrates, proteins, and lipids.

The term “alginate(s)” is used to refer generally to alginate(s) or salts thereof, alginic acid(s) or salts thereof, and/or alginate derivative(s) or salts thereof, unless a specific species is stated and/or the context dictates otherwise.

As used herein, a “biologically pure” strain is intended to mean the strain separated from materials with which it is normally associated in nature. A strain associated with other strains, or with compounds or materials that it is not normally found with in nature, is still defined as “biologically pure.” A monoculture of a particular strain is, of course, “biologically pure.” In different embodiments, a “biologically pure” culture has been purified at least 2× or 5× or 10× or 50× or 100× or 1000× or higher (to the extent considered feasible by a skilled person in the art) from the material with which it is normally associated in nature. As a non-limiting example, if a culture is normally associated with soil, the organism can be biologically pure to an extent that its concentration in a given quantity of purified or partially purified material with which it is normally associated (e.g. soil) is at least 2× or 5× or 10× or 50× or 100× or 1000× or higher (to the extent considered feasible by a skilled person in the art) that in the original unpurified material.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

As used herein, the term “agriculturally acceptable carrier” refers to a material that can be used to deliver an agriculturally beneficial agent to a plant, plant part or plant growth medium (e.g., soil). As used herein, the term “soil-compatible carrier” refers to a material that can be added to a soil without causing/having an unduly adverse effect on plant growth, soil structure, soil drainage, or the like. As used herein, the term “seed-compatible carrier” refers to a material that can be added to a seed without causing/having an unduly adverse effect on the seed, the plant that grows from the seed, seed germination, or the like. As used herein, the term “foliar-compatible carrier” refers to a material that can be added to a plant or plant part without causing/having an unduly adverse effect on the plant, plant part, plant growth, plant health, or the like.

By artificially controlling aspects of the microalgae culturing process such as the organic carbon feed (e.g., acetic acid, acetate), oxygen levels, pH, and light, the culturing process differs from the culturing process that microalgae experiences in nature. In addition to controlling various aspects of the culturing process, intervention by human operators or automated systems occurs during the culturing of microalgae through contamination control methods to prevent the microalgae from being overrun and outcompeted by contaminating organisms (e.g., fungi, bacteria). By intervening in the microalgae culturing process, the impact of the contaminating microorganisms can be mitigated by suppressing the proliferation of containing organism populations and the effect on the microalgal cells (e.g., lysing, infection, death, clumping). Thus, through artificial control of aspects of the culturing process and intervening in the culturing process with contamination control methods, the microalgae culture produced as a whole and used in the described inventive compositions differs from the culture that results from a microalgae culturing process that occurs in nature.

Certain publicly available strains described herein are identified by the term “UTEX” followed by a unique identifier containing letters and/or numbers. The term “UTEX” refers to the UTEX Culture Collection of Algae located at 205 W. 24th St., Biological Labs 218, The University of Texas at Austin (A6700), Austin, Tex. 78712 USA. The UTEX Culture Collection of Algae provides over 3,000 different strains of algae, representing more than 500 genera, to the public for a modest charge including the strains disclosed herein.

### Desiccation Protectants

### Carboxyalkylcellulose, Hydroxyalkylcellulose, and Derivatives

The hydroxyl groups (—OH) of cellulose can be partially or fully reacted with various reagents to afford derivatives with useful properties like cellulose esters and cellulose ethers (—OR).

Treatment of cellulosic fibers with caustic solution, followed by chloroacetic acid, yields cellulose ethers substituted with carboxymethyl groups, a cellulose derivative referred to as carboxymethyl cellulose (“CMC”). CMC is often used as its sodium salt, sodium carboxymethyl cellulose.

Ether derivatives of cellulose that are used in the compositions and methods disclosed herein are presented in Table 1.

TABLE 1
Non-limiting examples of cellulose ethers used in the disclosed compositions and methods.

| Cellulose | | | | | Water |
|---|---|---|---|---|---|
| ethers | Reagent | Example | Specific Reagent | Group R = H or | solubility |
| Hydroxy- | Epoxides | Hydroxyethyl | Ethylene oxide | —CH₂CH₂OH | Cold/Hot |
| alkylcellulose | | cellulose | | | Water- |
| | | | | | Soluble |
| | | Hydroxypropyl | Propylene oxide | —CH₂CH(OH)CH₃ | Cold Water- |
| | | cellulose (HPC) | | | Soluble |
| | | Hydroxyethyl | Chloromethane and | —CH₃ or | Cold Water- |
| | | methyl cellulose | ethylene oxide | —CH₂CH₂OH | Soluble |
| | | Hydroxypropyl | Chloromethane and | —CH₃ or | Cold Water- |
| | | methyl cellulose | propylene oxide | —CH₂CH(OH)CH₃ | Soluble |
| | | (HPMC) | | | |
| | | Ethyl hydroxyethyl | Chloroethane and | —CH₂CH₃ or | |
| | | cellulose | ethylene oxide | —CH₂CH₂OH | |
| Carboxy- | Halogenated | Carboxymethyl | Chloroacetic acid | —CH₂COOH | Cold/Hot |
| alkylcellulose | carboxylic | cellulose | | | Water- |
| | acids | (CMC) | | | Soluble |

### Alginate and Alginate Derivatives

Alginate is a linear, anionic polysaccharide consisting of two kinds of 1,4-linked hexuronic acid residues, namely β-d-mannuronopyranosyl (M) and α-1-guluronopyranosyl (G) residues, arranged in blocks of repeating M residues (MM blocks), blocks of repeating G residues (GG blocks), and blocks of mixed M and G residues (MG blocks). Alginate has an abundance of free hydroxyl and carboxyl groups distributed along the polymer chain backbone, and it, therefore, unlike neutral polysaccharides has two types of functional groups that can be modified to alter the characteristics in comparison to the parent compounds. Methods used for modification of hydroxyl groups of alginate include oxidation, reductive-amination, sulfation, copolymerization and coupling of cyclodextrin units. Methods used for modification of carboxyl groups include esterification, use of the Ugi reaction, and amidation.

Amphiphilic alginate derivatives are synthesized by introducing hydrophobic moieties (e.g., alkyl chains, hydrophobic polymers) to the alginate backbone. These derivatives can form self-assembled structures such as particles and gels in aqueous media. Amphiphilic derivatives of sodium alginate have been prepared by conjugation of long alkyl chains (i.e., dodecyl, octadecyl) to the alginate backbone via ester bond formation. Dodecylamine can be also conjugated to the alginate backbone via amide linkage formation using 2-chloro-1-methylpyridinium iodide as a coupling reagent. Sodium alginate can also be hydrophobically modified with poly(butylmethacrylate).

### Trehalose and Trehalose Derivatives

Trehalose is a disaccharide formed by a 1,1-glycosidic bond between two α-glucose units. It is also known as mycose or tremalose.

A trehalose derivative, in some cases, is a derivative of trehalose in which one or more of the hydroxyl groups of trehalose has been replaced with a protecting group or other group in a manner known in carbohydrate chemistry. In other non-limiting embodiments, a trehalose derivative can exhibit various direct or indirect linkages between the saccharide units. In one aspect, the trehalose derivative is trehalose choline chloride (TCH).

### Other Desiccation Protectants

Tamarind seed gum is an aqueous polysaccharide obtainable from seeds of Tamarindus grandiflora Pers. which is a perennial dicotyledon of the Fabaceous family. Locust bean gum is a polysaccharide obtainable from seeds of Ceratonia siliqua Linne. Xanthan gum is a fermented polysaccharide produced by the microorganism Xanthomonas campestris. Tara gum is an aqueous polysaccharide obtainable from seeds of Actinidia callosa Lindl. Guar gum is a polysaccharide obtainable from Cyamopsis tetragonoloba Taub. or an enzymatically (e.g., hemicellulase, etc.) degraded product of said polysaccharide. Pectin is a polysaccharide extractable from citrus fruits and apples using water and has methylated polygalacturonic acid as a principal component. Pectin can broadly be classified into HM pectin (50% or more methylated galacturonic acids out of the total galacturonic acid content) and LM pectin (below 50% methylated galacturonic acids out of the total galacturonic acid content), based on its degree of esterification (methoxyl group content). HM pectin and LM pectin can be both used in the present invention.

Pullulan is a polysaccharide produced by Aureobasidium pullulans [DE Bary] Am.). Psyllium seed gum is a polysaccharide obtainable from seeds of Plantago ovata Forsk. and other plants of the same genus. Carrageenan is a polysaccharide extracted using water from fronds of Chondrus crispus Lyngb., Gigartina tenella Harv., Eucheuma muricatum W. v. Bosse forma depaupaerata W. v. Bosse, Hypnea japonica Tanaka, and the like. Carrageenan can be classified into three main categories, kappa (κ), iota (τ) and lambda (λ), and any of κ-carrageenan, ι-carrageenan and λ-carrageenan can be used in the invention.

### Combinations of Gram-Negative Bacteria and a Desiccation Protectant

In certain aspects, the compositions of the present disclosure comprise a desiccation protectant; a plant growth promoting Gram-negative bacteria; and an agriculturally acceptable carrier.

Examples of genera of plant growth promoting Gram-negative bacteria include but are not limited to Pseudomonas, Burkholderia, Stenotrophomonas, Rhizobium, Bradyrhizobium, Sinorhizobium, Azospirillum, Herbaspirillum, Lysobacter, Pantoea, Azotobacter, Enterobacter, Klebsiella, Kosakonia, Rahnella, Sphingomonas, Massilia, Gluconacetobacter, Acetobacter, Asaia, Komagataeibacter, Nguyenibacter, Swaminathania, Janthinobacterium, Duganella, Methylobacterium, Flavobacterium, Serratia, and Variovorax.

In certain aspects, the plant growth promoting Gram-negative bacteria belong to the genus Pseudomonas. In one aspect, the plant growth promoting Gram-negative bacteria belong to one or more of the following species: Pseudomonas stutzeri, Pseudomonas fluorescens, Pseudomonas brassicacearum, Pseudomoas frederiksbergensis, Pseudomonas fulva, Pseudomonas syringae, Pseudomonas putida, Pseudomonas plecoglossicida, Pseudomonas mosselii, Pseudomonas gessardii, Pseudomonas libanensis, Pseudomonas oryzihabitans, and Pseudomonas geniculate. In another aspect, the plant growth promoting Gram-negative bacteria are Pseudomonas jessenii PS06.

In certain aspects, the plant growth promoting Gram-negative bacteria belong to the genus Kosakonia. In one aspect, the plant growth promoting Gram-negative bacteria belong to one or more of the following species: Kosakonia radicincitans, Kosakonia pseudosacchari, and Kosakonia sacchari. In another aspect, the plant growth promoting Gram-negative bacteria are one or more of: Kosakonia sacchari isolate PBC6, Kosakonia sacchari NCMA Accession No. 201701001, Kosakonia sacchari NCMA Accession No. 201701002, Kosakonia sacchari NCMA Accession No. 201701003, Kosakonia sacchari NCMA Accession No. 201701004, Kosakonia sacchari NCMA Accession No. 201708002, Kosakonia sacchari NCMA Accession No. 201708003, Kosakonia sacchari NCMA Accession No. 201708004, Kosakonia radicincitans NRRL Accession No. NRRL B-67171, and Kosakonia radicincitans strain BCI 107.

In certain aspects, the plant growth promoting Gram-negative bacteria belong to the genus Klebsiella. In one aspect, the plant growth promoting Gram-negative bacteria belong to one or more of the following species: Klebsiella oxytoca, Klebsiella pneumoniae, and Klebsiella variicola. In another aspect, the plant growth promoting Gram-negative bacteria are one or more of: Klebsiella variicola NCMA Accession No. 201708001, Klebsiella variicola NCMA Accession No. 201712001, Klebsiella variicola NCMA Accession No. 201712002, and Klebsiella oxytoca M5A1.

In certain aspects, the plant growth promoting Gram-negative bacteria belong to the genus Rahnella. In one aspect, the plant growth promoting Gram-negative bacteria belong to the following species: Rahnella aquatilis. In another aspect, the plant growth promoting Gram-negative bacteria are one or more of: Rahnella aquatilis strain CI019, Rahnella aquatilis Accession No. PTA-122293, and Rahnella aquatilis strain H145.

In certain aspects, the plant growth promoting Gram-negative bacteria belong to the genus Rhizobium. In one aspect, the plant growth promoting Gram-negative bacteria belong to the following species: Rhizobium etli, Rhizobium leguminosarum, Rhizobium phaseoli, Rhizobium tropici, Rhizobium fredii, and Rhizobium meliloti. In another aspect, the plant growth promoting Gram-negative bacteria are Rhizobium leguminosarum SO12A-2 (IDAC 080305-01).

In certain aspects, the plant growth promoting Gram-negative bacteria belong to the genus Azotobacter. In one aspect, the plant growth promoting Gram-negative bacteria belong to one or more of the following species: Azotobacter vinelandii and Azotobacter chroococcum.

In certain aspects, the plant growth promoting Gram-negative bacteria belong to the genus Massilia. In one aspect, the plant growth promoting Gram-negative bacteria belong to one or more of the following species: Massilia timonae, Massilia dura, Massilia albidiflava, Massilia plicata, Massilia lutea, Massilia aerilata, Massilia alkalitolerans, Massilia aurea, Massilia arvi, Massilia brevitalea, Massilia cf. timonae, Massilia consociate, Massilia eurypsychrophila, Massilia haematophila, Massilia jejuensis, Massilia kyonggiensis, Massilia lurida, Massilia niabensis, Massilia niastensis, Massilia norwichensis, Massilia oculi, Massilia putida, Massilia suwonensis, Massilia tieshanensis, Massilia umbonate, Massilia varians, and Massilia yuzhufengensis.

In certain aspects, the plant growth promoting Gram-negative bacteria belong to the genus Gluconacetobacter. In one aspect, the plant growth promoting Gram-negative bacteria belong to one or more of the following species: Gluconacetobacter aggeris, Gluconacetobacter asukensis, Gluconacetobacter azotocaptans, Gluconacetobacter diazotrophicus, Gluconacetobacter entanii, Gluconacetobacter europaeus, Gluconacetobacter hansenii, Gluconacetobacter intermedius, Gluconacetobacter johannae, Gluconacetobacter kakiaceti, Gluconacetobacter kombuchae, Gluconacetobacter liquefaciens, Gluconacetobacter maltaceti, Gluconacetobacter medellinensis, Gluconacetobacter nataicola, Gluconacetobacter oboediens, Gluconacetobacter rhaeticus, Gluconacetobacter sacchari, Gluconacetobacter saccharivorans, Gluconacetobacter sucrofermentans, Gluconacetobacter swingsii, Gluconacetobacter takamatsuzukensis, Gluconacetobacter tumulicola, Gluconacetobacter tumulisoli, and Gluconacetobacter xylinus.

In certain aspects, the plant growth promoting Gram-negative bacteria belong to the genus Acetobacter. In one aspect, the plant growth promoting Gram-negative bacteria belong to one or more of the following species: Acetobacter nitrogenifigens, Acetobacter sacchari, and Acetobacter peroxydans.

In certain aspects, the plant growth promoting Gram-negative bacteria belong to the genus Asaia. In one aspect, the plant growth promoting Gram-negative bacteria belong to one or more of the following species: Asaia siamensis, Asaia krungthepensis, Asaia lannaensis, Asaia platycodi, Asaia prunellae, and Asaia astilbes.

In certain aspects, the plant growth promoting Gram-negative bacteria belong to the genus Swaminathania. In one aspect, the plant growth promoting Gram-negative bacteria belong to one or more of the following species: S. salitorerans.

In certain aspects, the plant growth promoting Gram-negative bacteria belong to the genus Nguyenibacter vanlangensis. In one aspect, the plant growth promoting Gram-negative bacteria belong to one or more of the following species: Nguyenibacter vanlangensis.

In certain aspects, the plant growth promoting Gram-negative bacteria belong to the genus Komagataeibacter. In one aspect, the plant growth promoting Gram-negative bacteria belong to one or more of the following species: Komagataeibacter hansenii, Komagataeibacter kakiaceti, Komagataeibacter swingsii, Komagataeibacter intermedius

In certain aspects, the plant growth promoting Gram-negative bacteria belong to the genus Herbaspirillum. In one aspect, the plant growth promoting Gram-negative bacteria belong to one or more of the following species: H. aquaticum, H. autotrophicum, H. chlorophenolicum, H. frisingense, H. hiltneri, H. huttiense, H. lusitanum, H. massiliense, H. rhizosphaerae, H. rubrisubalbicans, and H. seropedicae.

In certain aspects, the plant growth promoting Gram-negative bacteria belong to the genus Lysobacter. In one aspect, the plant growth promoting Gram-negative bacteria belong to one or more of the following species: Lysobacter aestuarii, Lysobacter agri, Lysobacter antibioticus, Lysobacter arseniciresistens, Lysobacter brunescens, Lysobacter burgurensis, Lysobacter capsica, Lysobacter caeni, Lysobacter capsici, Lysobacter cavernae, Lysobacter concretionis, Lysobacter daejeonensis, Lysobacter dejluvii, Lysobacter dokdonensis, Lysobacter enzymogenes, Lysobacter erysipheiresistens, Lysobacter firmicutimachus, Lysobacter fragariae, Lysobacter ginsengisoli, Lysobacter gummosus, Lysobacter hankyongensis, Lysobacter humi, Lysobacter koreensis, Lysobacter korlensis, Lysobacter lycopersici, Lysobacter maris, Lysobacter mobilis, Lysobacter niabensis, Lysobacter niastensis, Lysobacter novalis, Lysobacter olei, Lysobacter oligotrophicus, Lysobacter oryzae, Lysobacter panacisoli, Lysobacter panaciterrae, Lysobacter rhizophilus, Lysobacter rhizosphaerae, Lysobacter ruishenii, Lysobacter sediminicola, Lysobacter silvestris, Lysobacter solanacearum, Lysobacter soli, Lysobacter spongiicola, Lysobacter terrae, Lysobacter terricola, Lysobacter thermophilus, Lysobacter tolerans, Lysobacter ximonensis, Lysobacter xinjiangensis, and Lysobacter yangpyeongensis.

In certain aspects, the plant growth promoting Gram-negative bacteria belong to the genus Pantoea. In one aspect, the plant growth promoting Gram-negative bacteria belong to one or more of the following species: Pantoea alhagi, Pantoea agglomerans, Pantoea Pantoea ananatis, Pantoea anthophila, Pantoea deleyi, Pantoea dispersa, Pantoea eucalypti, Pantoea stewartia, and Pantoea intestinalis.

In certain aspects, the plant growth promoting Gram-negative bacteria belong to the genus Janthinobacterium. In one aspect, the plant growth promoting Gram-negative bacteria belong to one or more of the following species: Janthinobacterium agaricidamnosum, Janthinobacterium aquaticum, Janthinobacterium lividum, Janthinobacterium psychrotolerans, Janthinobacterium rivuli, Janthinobacterium svalbardensis, and Janthinobacterium violaceinigrum.

In certain aspects, the plant growth promoting Gram-negative bacteria belong to the genus Duganella. In one aspect, the plant growth promoting Gram-negative bacteria belong to one or more of the following species: Duganella ginsengisoli, Duganella phyllosphaerae, Duganella radices, Duganella sacchari, and Duganella zoogloeoides.

In certain aspects, the plant growth promoting Gram-negative bacteria belong to the genus Methylobacterium. In one aspect, the plant growth promoting Gram-negative bacteria belong to one or more of the following species: M. adhaesivum, M. aerolatum, M. aminovorans, M. aquaticum, M. brachiatum, M. brachythecii, M. bullatum, M. cerastii, M. dankookense, M. extorquens, M. frigidaeris, M. fujisawaense, M. gnaphalii, M. goesingense, M. gossipiicola, M. gregans, M. haplocladii, M. hispanicum, M. iners, M. isbiliense, M. jeotgali, M. komagatae, M. longum, M. marchantiae, M. mesophilicum, M. nodulans, M. organophilum, M. oryzae, M. oxalidis, M. persicinum, M. phyllosphaerae, M. phyllostachyos, M. platani, M. podarium, M. populi, M. pseudosasae, M. pseudosasicola, M. radiotolerans, M. rhodesianum, M. rhodinum, M. salsuginis, M. soh, M. suomiense, M. tardum, M. tarhaniae, M. thiocyanatum, M. thuringiense, M. trifolii, M. variabile, and M. zatmanii.

In certain aspects, the plant growth promoting Gram-negative bacteria belong to the genus Flavobacterium. In one aspect, the plant growth promoting Gram-negative bacteria belong to one or more of the following species: F. acidificum, F. aciduliphilum, F. acidurans, F. ahnfeltiae, F. algicola, F. anatoliense, F. anhuiense, F. antarcticum, F. aquaticum, F. akiainvivens, F. aquatile, F. aquicola, F. aquidurense, F. araucananum, F. arcticum, F. arsenatis, F. arsenitoxidans, F. aureus, F. banpakuense, F. beibuense, F. branchiarum, F. branchiicola, F. branchiophilum, F. breve, F. brevivitae, F. buctense, F. caeni, F. cauense, F. ceti, F. cheniae, F. cheonanense, F. cheonhonense, F. chilense, F. chungangense, F. chungbukense, F. chungnamense, F. collinsense, F. collinsii, F. columnare, F. compostarboris, F. crassostreae, F. croceum, F. cucumis, F. cutihirudinis, F. daejeonense, F. daemonensis, F. dankookense, F. defluvii, F. degerlache, F. denitrificans, F. devorans, F. disper sum, F. dongtanense, F. eburneum, F. endophyticum, F. enshiense, F. faecale, F. ferrugineum, F. filum, F. flaviflagrans, F. flevense, F. fluvii, F. fontis, F. frigidarium, F. frigidimaris, F frigoris, F. fryxellicola, F. fulvum, F. gelidilacus, F. gillisiae, F. ginsengisoli, F. ginsenosidimutans, F. glaciei, F. glycines, F. granuli, F. halmophilum, F. haoranii, F. hauense, F. hercynium, F. hibernum, F. humicola, F. hydatis, F. indicum, F. inkyongense, F. jejuense, F. johnsoniae, F. jumunjinense, F. koreense, F. kyungheense, F. lacunae, F. lacus, F. limicola, F. limnosediminis, F. lindanitolerans, F. longum, F. luticocti, F. lutivivi, F. macrobrachia, F. maotaiense, F. marinum, F. marls, F. micromati, F. mizutaii, F. myungsuense, F. multivorum, F. nitratireducens, F. nitrogenifigens, F. noncentrifugens, F. notoginsengisoli, F. oceanosedimentum, F. omnivorum, F. oncorhynchi, F. okeanokoites, F. orientale, F. oryzae, F. palustre, F. paronense, F. pectinovorum, F. pedocola, F. phragmitis, F. piscis, F. plurextorum, F. ponti, F. procerum, F. psychrolimnae, F. psychrophilum, F. qiangtangense, F. rakeshii, F. reichenbachii, F. resisters, F. rivuli, F. saccharophilum, F. saliperosum, F. sasangense, F. segetis, F. salegens, F. seoulense, F. sinopsychrotolerans, F. soli, F. spartansii, F. squillarum, F. suaedae, F. subsaxonicum, F. succinans, F. suncheonense, F. suzhouense, F. swingsii, F. tegetincola, F. terrae, F. terrigena, F. terriphilum, F. thermophilum, F. tiangeerense, F. tilapiae, F. tistrianum, F. tructae, F. tyrosinilyticum, F. ummariense, F. urocaniciphilum, F. urumqiense, F. verecundum, F. vireti, F. weaverense, F. xanthum, F. xinjiangense, F. xueshanense, F. yanchengense, and F. yonginense.

In certain aspects, the plant growth promoting Gram-negative bacteria belong to the genus Serratia. In one aspect, the plant growth promoting Gram-negative bacteria belong to one or more of the following species: S. aquatilis, S. entomophila, S. ficaria, S. fonticola, S. glossinae, S. grimesii, S. liquefaciens, S. marcescens, S. myotis, S. nematodiphila, S. odorifera, S. plymuthica, S. proteamaculans, S. quinivorans, S. rubidaea, S. symbiotica, S. ureilytica, and S. vespertilionis.

In certain aspects, the plant growth promoting Gram-negative bacteria belong to the genus Variovorax. In one aspect, the plant growth promoting Gram-negative bacteria belong to one or more of the following species: Variovorax boronicumulans, Variovorax defluvii, Variovorax dokdonensis, Variovorax ginsengisoli, Variovorax gossypii, Variovorax guangxiensis, Variovorax humicola, Variovorax paradoxus, and Variovorax soli. In another aspect, the plant growth promoting Gram-negative bacteria belongs to the species of Variovorax guangxiensis.

In certain aspects, the plant growth promoting Gram-negative bacteria belong to the genus Azospirillum. In one aspect, the plant growth promoting Gram-negative bacteria belong to one or more of the following species: Azospirillum brasilense, Azospirillum lipoferum, Azospirillum halopraeferans, and Azospirillum amazonense. In another aspect, the plant growth promoting Gram-negative bacteria are Azospirillum brasilense INTA Az-39.

In certain aspects, the plant growth promoting Gram-negative bacteria belong to the genus Enterobacter. In one aspect, the plant growth promoting Gram-negative bacteria belong to the following species: Enterobacter cloacae. In another aspect, the plant growth promoting Gram-negative bacteria are one or more of: Enterobacter cloacae strain FERM BP 1529, Enterobacter cloacae strain CAP12 (NRRL No. B-50822), and Enterobacter sp. 638.

In certain aspects, the plant growth promoting Gram-negative bacteria belong to the genus Burkholderia. In one aspect, the plant growth promoting Gram-negative bacteria belong to one or more of the following species: Burkholderia gladioli, Burkholderia oxyphila, Burkholderia sacchari, Burkholderia ferrariae, Burkholderia silvatlantica, Burkholderia heleia, Burkholderia nodosa, Burkholderia bannensis, Burkholderia tropica, Burkholderia unamae, Burkholderia kururiensis, Burkholderia diazotrophica, Burkholderia tuberum, Burkholderia acidipaludis, Burkholderia caribensis, Burkholderia hospita, Burkholderia terrae, Burkholderia phymatum, Burkholderia sabiae, Burkholderia sartisoli, Burkholderia phenazinium, Burkholderia sediminicola, Burkholderia phytofirmans, Burkholderia ginsengisoli, Burkholderia fungorum, Burkholderia megapolitana, Burkholderia bryophila, Burkholderia terricola, Burkholderia graminis, Burkholderia phenoliruptrix, Burkholderia xenovocans, Burkholderia mimosarum, Burkholderia endofungorum, Burkholderia rhizoxinica, Burkholderia soli, Burkholderia caryophlii, Burkholderia unamae, and Burkholderia caledonica.

In another aspect, the plant growth promoting Gram-negative bacteria are one or more of: Burkholderia strain Q208 and Burkholderia-like species strain SOS1.

In certain aspects, the plant growth promoting Gram-negative bacteria belong to the genus Sinorhizobium. In one aspect, the plant growth promoting Gram-negative bacteria belong to one or more of the following species: Sinorhizobium fredii, Sinorhizobium medicae and Sinorhizobium meliloti. In another aspect, the plant growth promoting Gram-negative bacteria are one or more of: Sinorhizobium meliloti Rm1021, Sinorhizobium (Ensifer) meliloti strain RBD1, Sinorhizobium medicae strain NRRL Accession No. X78, Sinorhizobium meliloti strain NRRL Accession No. X79, Sinorhizobium fredii CCBAU114, and Sinorhizobium fredii USDA 205.

In certain aspects, the plant growth promoting Gram-negative bacteria belong to the genus Bradyrhizobium. In one aspect, the plant growth promoting Gram-negative bacteria belong to one or more of the following species: Bradyrhizobium diazoefficiens, Bradyrhizobium japonicum, Bradyrhizobium elkanii, Bradyrhizobium canariense, Bradyrhizobium denitrificans Bradyrhizobium iriomotense, Bradyrhizobium jicamae, Bradyrhizobium liaoningense, Bradyrhizobium pachyrhizi, and Bradyrhizobium yuanmingense. In another aspect, the plant growth promoting Gram-negative bacteria are one or more of Bradyrhizobium elkanii SEMIA 501, Bradyrhizobium elkanii SEMIA 587, Bradyrhizobium elkanii SEMIA 5019, Bradyrhizobium japonicum NRRL B-50586 (also deposited as NRRL B-59565), Bradyrhizobium japonicum NRRL B-50587 (also deposited as NRRL B-59566), Bradyrhizobium japonicum NRRL B-50588 (also deposited as NRRL B-59567), Bradyrhizobium japonicum NRRL B-50589 (also deposited as NRRL B-59568), Bradyrhizobium japonicum NRRL B-50590 (also deposited as NRRL B-59569), Bradyrhizobium japonicum NRRL B-50591 (also deposited as NRRL B-59570), Bradyrhizobium japonicum NRRL B-50592 (also deposited as NRRL B-59571), Bradyrhizobium japonicum NRRL B-50593 (also deposited as NRRL B-59572), Bradyrhizobium japonicum NRRL B-50594 (also deposited as NRRL B-50493), Bradyrhizobium japonicum NRRL B-50608, Bradyrhizobium japonicum NRRL B-50609, Bradyrhizobium japonicum NRRL B-50610, Bradyrhizobium japonicum NRRL B-50611, Bradyrhizobium japonicum NRRL B-50612, Bradyrhizobium japonicum NRRL B-50726, Bradyrhizobium japonicum NRRL B-50727, Bradyrhizobium japonicum NRRL B-50728, Bradyrhizobium japonicum NRRL B-50729, Bradyrhizobium japonicum NRRL B-50730, Bradyrhizobium japonicum SEMIA 566, Bradyrhizobium japonicum SEMIA 5079, Bradyrhizobium japonicum SEMIA 5080, Bradyrhizobium japonicum USDA 6, Bradyrhizobium japonicum USDA 110, Bradyrhizobium japonicum USDA 122, Bradyrhizobium japonicum USDA 123, Bradyrhizobium japonicum USDA 127, Bradyrhizobium japonicum USDA 129 and Bradyrhizobium japonicum USDA 532C.

Plants Benefitting from Application of the Compositions

Many plants can benefit from the application of compositions that provide a bio-stimulatory effect. Non-limiting examples of plant families that can benefit from such compositions include plants from the following: Solanaceae, Fabaceae (Leguminosae), Poaceae, Roasaceae, Vitaceae, Brassicaeae (Cruciferae), Caricaceae, Malvaceae, Sapindaceae, Anacardiaceae, Rutaceae, Moraceae, Convolvulaceae, Lamiaceae, Verbenaceae, Pedaliaceae, Asteraceae (Compositae), Apiaceae (Umbelliferae), Araliaceae, Oleaceae, Ericaceae, Actinidaceae, Cactaceae, Chenopodiaceae, Polygonaceae, Theaceae, Lecythidaceae, Rubiaceae, Papveraceae, Illiciaceae Grossulariaceae, Myrtaceae, Juglandaceae, Bertulaceae, Cucurbitaceae, Asparagaceae (Liliaceae), Alliaceae (Liliceae), Bromeliaceae, Zingieraceae, Muscaceae, Areaceae, Dioscoreaceae, Myristicaceae, Annonaceae, Euphorbiaceae, Lauraceae, Piperaceae, Proteaceae, and Cannabaceae.

The Solanaceae plant family includes a large number of agricultural crops, medicinal plants, spices, and ornamentals in its over 2,500 species. Taxonomically classified in the Plantae kingdom, Tracheobionta (subkingdom), Spermatophyta (superdivision), Magnoliophyta (division), Manoliopsida (class), Asteridae (subclass), and Solanales (order), the Solanaceae family includes, but is not limited to, potatoes, tomatoes, eggplants, various peppers, tobacco, and petunias. Plants in the Solanaceae can be found on all the continents, excluding Antarctica, and thus have a widespread importance in agriculture across the globe.

The Rosaceae plant family includes flowering plants, herbs, shrubs, and trees. Taxonomically classified in the Plantae kingdom, Tracheobionta (subkingdom), Spermatophyta (superdivision), Magnoliophyta (division), Magnoliopsida (class), Rosidae (subclass), and Rosales (order), the Rosaceae family includes, but is not limited to, almond, apple, apricot, blackberry, cherry, nectarine, peach, plum, raspberry, strawberry, and quince.

The Fabaceae plant family (also known as the Leguminosae) comprises the third largest plant family with over 18,000 species, including a number of important agricultural and food plants. Taxonomically classified in the Plantae kingdom, Tracheobionta (subkingdom), Spermatophyta (superdivision), Magnoliophyta (division), Manoliopsida (class), Rosidae (subclass), and Fabales (order), the Fabaceae family includes, but is not limited to, soybeans, beans, green beans, peas, chickpeas, alfalfa, peanuts, sweet peas, carob, and liquorice. Plants in the Fabaceae family can range in size and type, including but not limited to, trees, small annual herbs, shrubs, and vines, and typically develop legumes. Plants in the Fabaceae family can be found on all the continents, excluding Antarctica, and thus have a widespread importance in agriculture across the globe. Besides food, plants in the Fabaceae family can be used to produce natural gums, dyes, and ornamentals.

The Poaceae plant family supplies food, building materials, and feedstock for fuel processing. Taxonomically classified in the Plantae kingdom, Tracheobionta (subkingdom), Spermatophyta (superdivision), Magnoliophyta (division), Liliopsida (class), Commelinidae (subclass), and Cyperales (order), the Poaceae family includes, but is not limited to, flowering plants, grasses, and cereal crops such as barely, corn, lemongrass, millet, oat, rye, rice, wheat, sugarcane, and sorghum. Types of turf grass found in Arizona include, but are not limited to, hybrid Bermuda grasses (e.g., 328 tifgrn, 419 tifway, tif sport).

The Vitaceae plant family includes flowering plants and vines. Taxonomically classified in the Plantae kingdom, Tracheobionta (subkingdom), Spermatophyta (superdivision), Magnoliophyta (division), Magnoliopsida (class), Rosidae (subclass), and Rhammales (order), the Vitaceae family includes, but is not limited to, grapes.

In certain aspects, any of a variety of plants may benefit from the workings of the composition according to the invention. In one embodiment, the plant is an ornamental plant, which includes flowering and non-flowering plants. In another embodiment, the plant is a consumable plant, which includes cereals, crops, fruit trees, herbs, medicinal plants and vegetables. In another embodiment, the plant is a member of the Alliaceae, Apiaceae, Asparagaceae, Asphodelaceae, Asteraceae, Araucariaceae, Begoniaceae, Brassicaceae, Bromeliaceae, Buxaceae, Chenopidiaceae, Cichorioideae, Chenopodiaceae, Coniferae, Cucurbitaceae, Fabaceae, Gentianaceae, Gramineaejridaceae, Leguminosae, Liliaceae, Malvaceae, Marantaceae, Marasmiaceae, Musaceae, Oleaceae, Orchidaceae, Paeoniaceae, Pleurotaceae, Pinaceae, Poaceae, Rosaceae, Rubiaceae, Rutaceae, Salicaceae, Solanaceae, Sterculiaceae, Taxaceae, Tuberacea, Vandeae, Vitacea or Xanthorrhoeaceae family, preferably of the Asteraceae, Begoniaceae, Brassicaceae, Chenopodiaceae, Cucurbitaceae, Gramineae, Leguminosae, Liliaceae, Malvaceae, Musaceae, Orchidaceae, Paeoniaceae, Rosaceae, Rubiaceae, Rutaceae, Salicaceae, Solanaceae, Sterculiaceae or Vandeae family, most preferably of the Begoniaceae, Brassicaceae, Orchidaceae, Paeoniaceae, Rosaceae or Solanaceae family. The plant may be a species of the genus Alchemilla, Allium, Aloe, Alstroemeria, Arabidopsis, Argyranthemum, Avena, Begonia, Brassica, Bromelia, Buxus, Calathea, Campanula, Capsicum, Cattleya, Cichorium, Citrus, Chamaecyparis, Chrysanthemum, Clematis, Cucumis, Cyclamen, Cydonia, Cymbidium, Cynodon, Dianthus, Dracaena, Eriobotrya, Euphorbia, Eustoma, Ficus, Fragaria, Fuchsia, Gaultheria, Gerbera, Glycine, Gypsophilia, Hedera, Helianthus, Hordeum, Hyacinthus, Hydrangea, Hippeastrum, Iris, Kalanchoe, Lactuca, Lathyrus, Lavendula, Lilium, Limonium, Malus, Mandevilla, Olea, Oryza, Osteospermum, Paeonia, Panicum, Pelargonium, Petunia, Phalaenopsis, Phaseolus, Pinus, Pisum, Platycodon, Prunus, Pyrus, Ranunculus, Rhododendron, Rosa, Rubus, Ruta, Secale, Skimmia, Solanum, Sorbus, Sorghum, Spathiphyllum, Trifolium, Triticum, Tulipa, Vanda, Vicia, Viola, Vitis, Zamioculcas or Zea. Preferably, the plant is a species of Arabidopsis, Begonia, Brassica, Fragaria, Paeonia, Phalaenopsis, Rosa, Solanum or Vanda.

In particular, the composition may be used to promote the growth of commercially important crops and plants, such as alfalfa, apples, bananas, begonias, bromeliads, cereals, cherries, citrus fruits, grapes, maize, melons, olives, onions, orchids, peaches, peonies, potatoes, rice, soybeans, canola, sugar beets, spinach, strawberries, tomatoes or wheat.

The composition according to the invention may also be used for improving the growth or development of seeds, tubers or bulbs. The composition may be used as such or may be mixed with substrate or nutrition medium. It may be applied to the seeds, tubers or bulbs in any convenient way, including pouring, soaking and spraying. In one embodiment, the composition according to the invention is used to coat seeds, tubers or bulbs.

The effect of the application of the composition according to the invention is improved growth, such as improved root development, improved nutrient assimilation, improved efficiency of plant metabolism or increased photosynthesis. This may be apparent from improved yield, improved leaf formation, improved color formation, improved flowering, improved fruit formation, improved taste or improved health compared to a similar plant to which the liquid composition according to the invention has not been applied.

Improvements may be determined in any suitable way generally used by the person skilled in the art, for example by counting, weighing or measuring. Improvement in any one of these areas may be at least 5%, at least 10%, at least 15%, at least 20%, at least 30%, at least 40%, at least 50%, at least 60%, at least 70%, at least 80%, at least 90%, at least 100%, at least 200%, or at least 300%, such as about 5% to 50%, about 5% to 100%, about 10% to 100%, about 20% to 50%, about 20% to 100% or about 100% to 200%.

Improved root development may be reflected in several ways, such as by more roots per plant, more roots per square area, accelerated root formation, earlier root formation, stronger roots, thicker roots, better functioning roots, more branched roots or a wider spread root network.

Improved yield may be reflected in several ways, such as by more plants per area, more branches per plant, more buds per plant, more bulbs per plant, more fruits per plant, more flowers per plant, more leaves per plant, more seedlings from seed, more seeds per plant, more shoots per plant, more spores per plant, more starch per plant, more tubers per plant, more weight per plant, higher dry matter content, more primary metabolites per plant or more secondary metabolites per plant.

Improved growth may be reflected in several ways, such as by earlier germination, accelerated germination, accelerated stem growth, a thicker stem, earlier fruit formation, accelerated fruit formation, earlier ripening of fruit or accelerated ripening of fruit.

Improved leaf formation may be reflected in several ways, such as by more leaves per plant, more leaves per cm of stem, more buds per stem, larger leaves, broader leaves, thicker leaves, stronger leaves, better functioning leaves or earlier or accelerated leaf formation.

Improved color formation may be reflected in several ways, such as by earlier color formation, accelerated color formation, more diverse color formation, deeper color formation, more intense color or more stability of color.

Improved flowering may be reflected in several ways, such as by earlier flowering, accelerated flowering, larger flowers, more flowers, more open flowers, longer lasting flowers, longer open flowers, by flowers which are more diverse in color, by flowers having a desired color or by flowers with more stability of color.

Improved fruit formation may be reflected in several ways, such as by earlier fruit formation, accelerated fruit formation, longer period of bearing fruit, earlier ripening of fruit, accelerated ripening of fruit, more fruit, heavier fruit, larger fruit or tastier fruit.

Improved taste may be reflected in several ways, such as by less acidity, more sweetness, more flavor, more complex flavor profile, higher nutrient content or more juiciness.

Improved health may be reflected in several ways, such as by being more resistant to abiotic stress, being more resistant to biotic stress, being more resistant to chemical stress, being more resistant to physical stress, being more resistant to physiological stress, being more resistant to insect pests, being more resistant to fungal pests, growing more abundantly, flowering more abundantly, keeping leaves for a longer period or being more efficient in food uptake. In the present context, biotic stress factors include fungi and insects. Abiotic stress is the result of salinity, temperature, water or light conditions which are extreme to the plant under the given circumstances.

In one embodiment, the use of the composition according to the invention leads to harvesting more plants or plant parts per area, such as more barks, berries, branches, buds, bulbs, cut branches, cut flowers, flowers, fruits, leaves, roots, seeds, shoots, spores or tubers per plant per area. The use of the liquid composition according to the invention may lead to an increase in the yield of crops. The harvest may be more abundant, and harvesting may take place after a shorter period of time, in comparison with a situation in which the composition according to the invention is not applied.

In one embodiment, application of the liquid composition according to the invention leads to more kilos of flowers, fruits, grains or vegetables, such as apples, auberges, bananas, barley, bell peppers, blackberries, blue berries, cherries, chives, courgettes, cucumber, endive, garlic, grapes, leek, lettuce, maize, melons, oats, onions, oranges, pears, peppers, potatoes, pumpkins, radish, raspberries, rice, rye, strawberries, sweet peppers, tomatoes or wheat.

In another embodiment, the application of the method according to the invention leads to more kilos of barks, berries, branches, buds, flowers, fruits, leaves, roots or seeds from culinary or medicinal herbs, such as basil, chamomile, catnip, chives, coriander, dill, eucalyptus, fennel, jasmine, lavas, lavender, mint, oregano, parsley, rosemary, sage, thyme and thus to more aroma, flavor, fragrance, oil or taste in the same period of time or in a shorter period of time, in comparison to a situation in which the composition according to the invention has not been applied.

In another embodiment, the use of the liquid composition according to the invention leads to a higher yield of antioxidants, colorants, nutrients, polysaccharides, pigments or terpenes. In one embodiment, the sugar content of the plant cells is increased.

The period of comparison with a control plant or control situation may be any period, from several hours, several days or several weeks to several months or several years. The area of comparison may be any area, such as square meters or hectares or per pot.

### Beneficial Effects of the Mixtures

In certain aspects, the disclosed mixtures induce increased plant resistance to environmental stresses including salinity, drought, pH, high/low temperature, and/or light intensity. In one aspect, the treated plants are more resistant to drought stress. In another aspect, the treated plants are resistant to heat stress or cold stress. In another aspect, the treated plants are resistant to a combination of heat stress and drought stress. As used herein, “drought stress” refers to watering conditions wherein plant growth is significantly slowed as compared to those where water availability is sufficient to support optimal growth and development.

Resistance to heat stress indicates that the crop plants demonstrate increased resistance to higher minimal and maximal day/night temperatures and in particular increased minimal temperatures. The resistance to heat stress may be demonstrated by a lack of reduction in the grain yield when the crop plants are grown under conditions of heat stress. Conditions of heat stress may be exemplified by growing the plants under conditions in which the crop plants are exposed to night temperatures of 25° C. or above, suitably 26° C. or above or even 27° C. as the minimal nighttime temperatures. Day temperatures as noted above generally do not have the same negative impact as increased minimal or nighttime temperatures. In particular, the crop plants are most affected by heat stress during the reproductive and ripening phases of growth of the plant. In rice, the increased minimal temperatures and heat stress has the most dramatic impact on grain yield and quality when the plants are exposed to increased temperatures from the boot stage to physiological maturity.

The grain yield may be measured by total yield/area or yield per plant. As demonstrated in the examples, the grain yield per plant in plants with increased expression of HYR protein may be over 5 g/plant when grown under conditions of heat stress as compared to less than 4 g/plant in controls. Suitably, the grain yield is over 5 g/plant, over 6 g/plant, over 7 g/plant or even more depending on the level of heat stress, timing of stress and length of exposure. The resistance to heat stress may also be demonstrated by maintenance of grain quality after exposure to heat stress as defined herein. The grain may be small in size or demonstrate an increase in chalkiness of the grains after exposure to heat. The grains may be less likely to be chalky and those that are chalky are less chalky than grain from control untreated plants. Suitably, the grain quality is improved by an at least 7%, 8%, 9%, 10% 11%, 12%, 14%, 15%, 16%, 18%, or even 20% reduction in chalkiness of the grain from plants when grown under heat stress. The reduction in chalkiness of the grains will depend on the level of heat stress, duration and timing of the exposure to such stress.

### Formulations

In some embodiments, the inventive compositions are liquid formulations. Non-limiting examples of liquid formulations include suspension concentrations and oil dispersions. In other embodiments, the inventive compositions are solid formulations. Non-limiting examples of liquid formulations include freeze-dried powders and spray-dried powders.

In a further aspect, the compositions can comprise a wetting agent or dispersant, a binder or adherent, an aqueous solvent and/or a non-aqueous co-solvent. The compositions provided herein can be formulated as a solid; as a powder, lyophilizate, pellet or granules; as a liquid or gel; or as an emulsion, colloid, suspension or solution.

Compositions of the present invention may include formulation inerts added to compositions comprising cells, cell-free preparations or metabolites to improve efficacy, stability, and usability and/or to facilitate processing, packaging and end-use application. Such formulation inerts and ingredients may include carriers, stabilization agents, nutrients, or physical property modifying agents, which may be added individually or in combination. In some embodiments, the carriers may include liquid materials such as water, oil, and other organic or inorganic solvents and solid materials such as minerals, polymers, or polymer complexes derived biologically or by chemical synthesis. In some embodiments, the carrier is a binder or adhesive that facilitates adherence of the composition to a plant part, such as a seed or root. See, for example, Taylor, A. G., et al., “Concepts and Technologies of Selected Seed Treatments”, Annu. Rev. Phytopathol. 28: 321-339 (1990). The stabilization agents may include anti-caking agents, anti-oxidation agents, desiccants, protectants or preservatives. The nutrients may include carbon, nitrogen, and phosphors sources such as sugars, polysaccharides, oil, proteins, amino acids, fatty acids and phosphates. The physical property modifiers may include bulking agents, wetting agents, thickeners, pH modifiers, rheology modifiers, dispersants, adjuvants, surfactants, film-formers, hydrotropes, builders, antifreeze agents or colorants. In some embodiments, the composition comprising cells, cell-free preparation and/or metabolites produced by fermentation can be used directly with or without water as the diluent without any other formulation preparation. In a particular embodiment, a wetting agent, or a dispersant, is added to a fermentation solid, such as a freeze-dried or spray-dried powder. A wetting agent increases the spreading and penetrating properties, or a dispersant increases the dispersibility and solubility of the active ingredient (once diluted) when it is applied to surfaces. Exemplary wetting agents are known to those of skill in the art and include sulfosuccinates and derivatives, such as MULTIWET™ MO-70R (Croda Inc., Edison, N.J.); siloxanes such as BREAK-THRU® (Evonik, Germany); nonionic compounds, such as ATLOX™ 4894 (Croda Inc., Edison, N.J.); alkyl polyglucosides, such as TERWET® 3001 (Huntsman International LLC, The Woodlands, Tex.); C12-C14 alcohol ethoxylate, such as TERGITOL® 15-S-15 (The Dow Chemical Company, Midland, Mich.); phosphate esters, such as RHODAFAC® BG-510 (Rhodia, Inc.); and alkyl ether carboxylates, such as EMULSOGEN™ LS (Clariant Corporation, North Carolina).

The formulations or application forms in question preferably comprise auxiliaries, such as extenders, solvents, spontaneity promoters, carriers, emulsifiers, dispersants, frost protectants, biocides, thickeners and/or other auxiliaries, such as adjuvants, for example. An adjuvant in this context is a component which enhances the biological effect of the formulation, without the component itself having a biological effect. Examples of adjuvants are agents which promote the retention, spreading, attachment to the leaf surface, or penetration.

These formulations are produced in a known manner, for example by mixing the active compounds with auxiliaries such as, for example, extenders, solvents and/or solid carriers and/or further auxiliaries, such as, for example, surfactants.

Suitable for use as auxiliaries are substances which are suitable for imparting to the formulation of the active compound or the application forms prepared from these formulations (such as, e.g., usable crop protection agents, such as spray liquors or seed dressings) particular properties such as certain physical, technical and/or biological properties.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

In principle it is possible to use all suitable solvents. Suitable solvents are, for example, aromatic hydrocarbons, such as xylene, toluene or alkylnaphthalenes, for example, chlorinated aromatic or aliphatic hydrocarbons, such as chlorobenzene, chloroethylene or methylene chloride, for example, aliphatic hydrocarbons, such as cyclohexane, for example, paraffins, petroleum fractions, mineral and vegetable oils, alcohols, such as methanol, ethanol, isopropanol, butanol or glycol, for example, and also their ethers and esters, ketones such as acetone, methyl ethyl ketone, methyl isobutyl ketone or cyclohexanone, for example, strongly polar solvents, such as dimethyl sulphoxide, and water.

All suitable carriers may in principle be used. Suitable carriers are in particular: for example, ammonium salts and ground natural minerals such as kaolins, clays, talc, chalk, quartz, attapulgite, montmorillonite or diatomaceous earth, and ground synthetic minerals, such as finely divided silica, alumina and natural or synthetic silicates, resins, waxes and/or solid fertilizers. Mixtures of such carriers may likewise be used. Carriers suitable for granules include the following: for example, crushed and fractionated natural minerals such as calcite, marble, pumice, sepiolite, dolomite, and also synthetic granules of inorganic and organic meals, and also granules of organic material such as sawdust, paper, coconut shells, maize cobs and tobacco stalks.

Liquefied gaseous extenders or solvents may also be used. Particularly suitable are those extenders or carriers which at standard temperature and under standard pressure are gaseous, examples being aerosol propellants, such as halogenated hydrocarbons, and also butane, propane, nitrogen and carbon dioxide.

Examples of emulsifiers and/or foam-formers, dispersants or wetting agents having ionic or nonionic properties, or mixtures of these surface-active substances, are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyltaurates), phosphoric esters of polyethoxylated alcohols or phenols, fatty acid esters of polyols, and derivatives of the compounds containing sulphates, sulphonates and phosphates, examples being alkylaryl polyglycol ethers, alkylsulphonates, alkyl sulphates, arylsulphonates, protein hydrolysates, lignin-sulphite waste liquors and methylcellulose. The presence of a surface-active substance is advantageous if one of the active compounds and/or one of the inert carriers is not soluble in water and if application takes place in water.

Further auxiliaries that may be present in the formulations and in the application forms derived from them include colorants such as inorganic pigments, examples being iron oxide, titanium oxide, Prussian Blue, and organic dyes, such as alizarin dyes, azo dyes and metal phthalocyanine dyes, and nutrients and trace nutrients, such as salts of iron, manganese, boron, copper, cobalt, molybdenum and zinc.

Stabilizers, such as low-temperature stabilizers, preservatives, antioxidants, light stabilizers or other agents which improve chemical and/or physical stability may also be present. Additionally present may be foam-formers or defoamers.

Furthermore, the formulations and application forms derived from them may also comprise, as additional auxiliaries, stickers such as carboxymethylcellulose, natural and synthetic polymers in powder, granule or latex form, such as gum arabic, polyvinyl alcohol, polyvinyl acetate, and also natural phospholipids, such as cephalins and lecithins, and synthetic phospholipids. Further possible auxiliaries include mineral and vegetable oils.

There may possibly be further auxiliaries present in the formulations and the application forms derived from them. Examples of such additives include fragrances, protective colloids, binders, adhesives, thickeners, thixotropic substances, penetrants, retention promoters, stabilizers, sequestrants, complexing agents, humectants and spreaders. Generally speaking, the active compounds may be combined with any solid or liquid additive commonly used for formulation purposes.

Suitable retention promoters include all those substances which reduce the dynamic surface tension, such as dioctyl sulphosuccinate, or increase the viscoelasticity, such as hydroxypropylguar polymers, for example.

Suitable penetrants in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

In some embodiments, the plant growth promoting Gram-negative bacteria and the EPS are incorporated into one or more agriculturally acceptable carriers.

Compositions of the present disclosure may comprise any suitable agriculturally acceptable carrier(s), including, but not limited to, seed-compatible carriers, foliar-compatible carriers and soil-compatible carriers.

In some embodiments, compositions of the present disclosure comprise one or more liquid and/or gel carriers. For example, in some embodiments, compositions of the present disclosure comprise an aqueous solvent and/or a nonaqueous solvent.

In some embodiments, compositions of the present disclosure comprise one or more inorganic solvents, such as decane, dodecane, hexylether and nonane; one or more organic solvents, such as acetone, dichloromethane, ethanol, hexane, methanol, propan-2-ol and trichloroethylene; and/or water.

Non-limiting examples of liquid/gel carriers that may be useful in compositions of the present disclosure include oils (e.g., mineral oil, olive oil, peanut oil, soybean oil, sunflower oil), polyethylene glycols (e.g., PEG 200, PEG 300, PEG 400, etc.), propylene glycols (e.g., PPG-9, PPG-10, PPG-17, PPG-20, PPG-26, etc.), ethoxylated alcohols (e.g., TOMADOL® (Air Products and Chemicals, Inc., Allentown, Pa.), TERGITOL™ 15-S surfactants such as TERGITOL™15-S-9 (The Dow Chemical Company, Midland, Mich.), etc.), polysorbates (e.g. polysorbate 20, polysorbate 40, polysorbate 60, polysorbate 80, etc.), silicones (siloxanes, trisiloxanes, etc.) and combinations thereof.

Additional examples of solvents that may be included in compositions of the present disclosure may be found in BURGES, FORMULATION OF MICROBIAL BIOPESTICIDES: BENEFICIAL MICROORGANISMS, NEMATODES AND SEED TREATMENTS (Springer Science & Business Media) (2012); Inoue & Horikoshi, J. FERMENTATION BIOENG. 71(3):194 (1991).

In some embodiments, compositions of the present disclosure comprise one or more solid carriers. For example, in some embodiments, compositions of the present disclosure comprise one or more powders (e.g., wettable powders) and/or granules.

Non-limiting examples of solid carriers that may be useful in compositions of the present disclosure include clays (e.g., attapulgite clays, montmorillonite clay, etc.), peat-based powders and granules, freeze-dried powders, spray-dried powders, spray-freeze-dried powders and combinations thereof.

Additional examples of solid carriers that may be included in compositions of the present disclosure may be found in BURGES, FORMULATION OF MICROBIAL BIOPESTICIDES: BENEFICIAL MICROORGANISMS, NEMATODES AND SEED TREATMENTS (Springer Science & Business Media) (2012).

Carriers incorporated into compositions of the present disclosure may comprise a growth medium suitable for culturing one or more of the microorganisms in the composition. For example, in some embodiments, compositions of the present disclosure comprise Czapek-Dox medium, glycerol yeast extract, mannitol yeast extract, potato dextrose broth and/or YEM media.

Selection of appropriate carrier materials will depend on the intended application(s) and the microorganism(s) present in the composition. In some embodiments, the carrier material(s) will be selected to provide a composition in the form of a liquid, gel, slurry, or solid.

Carriers may be incorporated into compositions of the present disclosure in any suitable amount(s)/concentration(s). The absolute value of the carrier amount/concentration/dosage may be affected by factors such as the type, size and volume of material to which the composition will be applied, the type(s) of microorganisms in the composition, the number of microorganisms in the composition, the stability of the microorganisms in the composition and storage conditions (e.g., temperature, relative humidity, duration). Those skilled in the art will understand how to select an effective amount/concentration/dosage using routine dose-response experiments.

In some embodiments, compositions of the present disclosure comprise one or more commercial carriers used in accordance with the manufacturer's recommended amounts/concentrations.

### Biological Deposit of Parachlorella Kessleri Accession No. NCMA 202103001

A Biological Deposit of Parachlorella kessleri Accession No. NCMA 202103001 was made at the Provasoli-Guillard National Center for Marine Algae and Microbiota—Bigelow Laboratory for Ocean Sciences, (NCMA, 60 Bigelow Drive, East Boothbay, Me. 04544 U.S.A.) on Mar. 3, 2021 under the provisions of the Budapest Treaty and assigned by the International Depositary Authority the accession number 202103001. Upon issuance of a patent, all restrictions upon the Deposit will be irrevocably removed, and the Deposit is intended to meet the requirements of 37 CFR §§ 1.801-1.809. The Deposit will be maintained in the depository for a period of 30 years, or 5 years after the last request, or for the effective, enforceable life of the patent, whichever is longer, and will be replaced if necessary during that period; and the requirements of 37 CFR §§ 1.801-1.809 are met.

The present invention is further illustrated by the following examples that should not be construed as limiting. The contents of all references, patents, and published patent applications cited throughout this application, as well as the Figures, are incorporated herein by reference in their entirety for all purposes.

### EXAMPLES

### Example 1. Effects of EPS and EPS-Related Chemical Compounds on the Desiccation Resistance of a Gram-Negative Kosakonia sp. Bacterium

Trehalose is a disaccharide made up of two molecules of glucose and can serve as a substrate for EPS biosynthesis (see Nicolaus, B., et al., Production and characterization of exopolysaccharides excreted by thermophilic bacteria from shallow, marine hydrothermal vents of Flegrean Ares (Italy). Syst Appl Microbiol. 2002 October; 25(3):319-25). Carboxymethylcellulose mimics polymers found in nature and has been used to produce synthetic EPS (see Go, L., et al. (2020). Kinetic and thermodynamic analyses of the corrosion inhibition of synthetic extracellular polymeric substances. PeerJ Materials Science. 2. e4). Alginates are polysaccharides produced by certain algae and bacteria (see Siddhesh N. Pawar, S N, et al., (2012) Alginate derivatization: A review of chemistry, properties and applications, Biomaterials, 33 (11): 3279-3305). The following experiment was performed to compare the ability of these EPS-related compounds with microalgal EPS in maintaining the viability of Gram-negative bacteria during desiccation stress.

A rifampicin-resistant strain of a Gram-negative Kosakonia sp. bacterium was mixed with water (untreated control or “UTC”), trehalose, carboxymethylcellulose (“CMC”), methylcellulose (“MC”), extracellular polymeric substance from Parachlorella kessleri Accession No. NCMA 202103001 (“EPS”), sodium alginate (“Na-Alginate”), Parachlorella kessleri Accession No. NCMA 202103001 whole broth (“3001 Broth”), or Parachlorella kessleri Accession No. NCMA 202103001 cell pellet after centrifugation (“3001 Pellet”) in 96-well plates. Each of the protectant agents was added undiluted (i.e., at a 1× dilution) or at a 2× dilution (i.e., at 2 parts water to 1 part protectant) for whole broth and cell pellets or at a concentration of 1% (i.e., 1 g/100 mL) or 0.5% (i.e., 0.5 g/100 mL) for all other protectants. The CMC used for these experiments was the sodium salt.

The liquid medium in the plates was allowed to dry at room temperature inside a desiccation chamber for several days to create desiccation stress in the bacterial cell cultures. Sterile water containing 0.02% (vol/vol) of a surfactant, SILWET® 77 (alkoxylated trisilane), was then added to the dried 96-well plates, and the resuspended cells were spotted onto culture plates containing rifampicin. The bacterial cells were evaluated for survival and growth after 5 days of desiccation stress and after 7 days of desiccation stress.

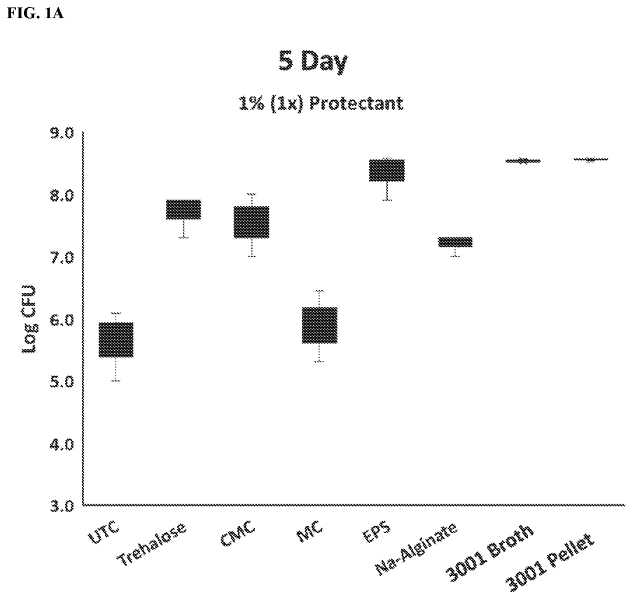

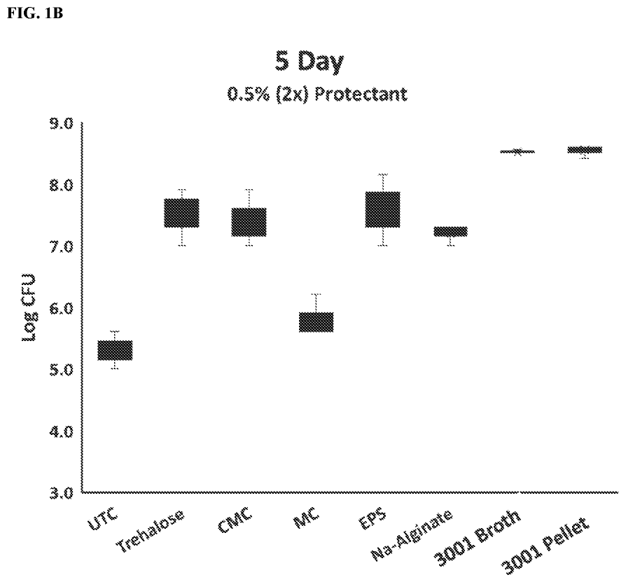

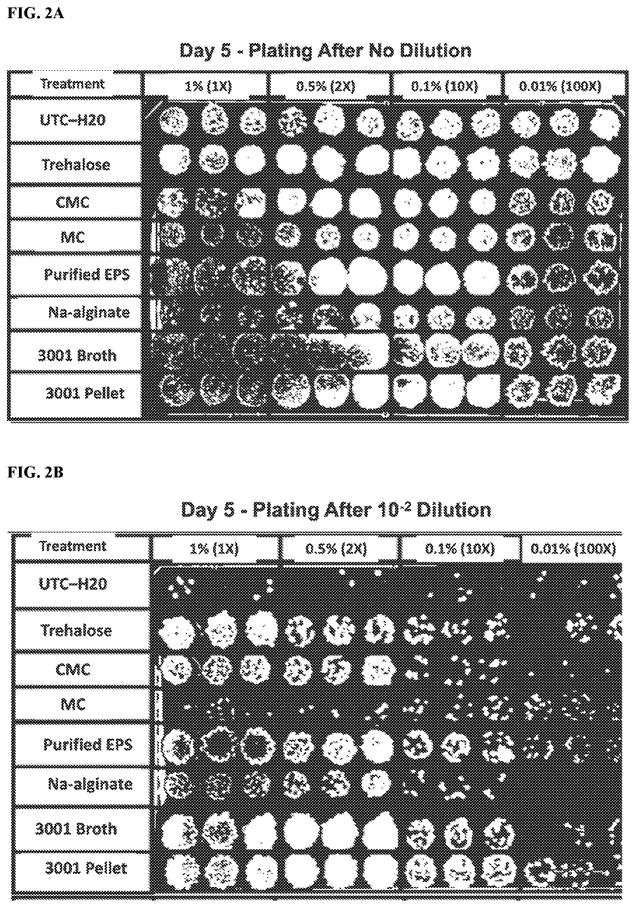

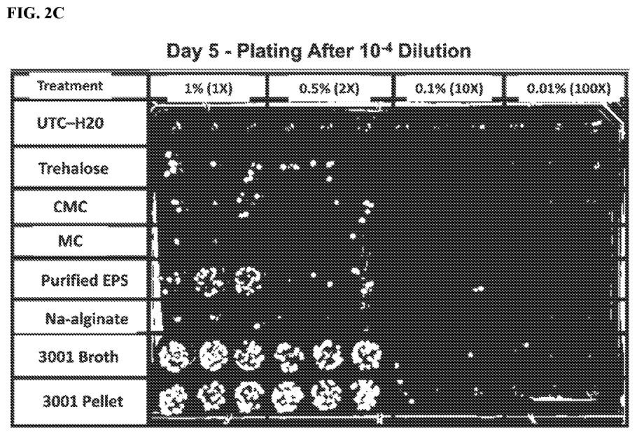

Viability results with the Kosakonia sp. cells after 5 days of desiccation stress are presented in FIGS. 1A and 1B. The colony forming unit (CFU) data in these figures were generated by counting the number of colonies on each spot (see spots on representative plates shown in FIGS. 2A, 2B, and 2C) and using the following formula for quantifying viable cell density:

$$Cell Density ( cfu / mL ) = \frac{\# of Colonies \times Dilution factor}{volume plated ( mL )}$$

In the cases where no colonies were found in the least diluted samples (generally in UTC-H₂O samples), the colony number of 0.5 was assigned to calculate cell density and subsequent log transformation.

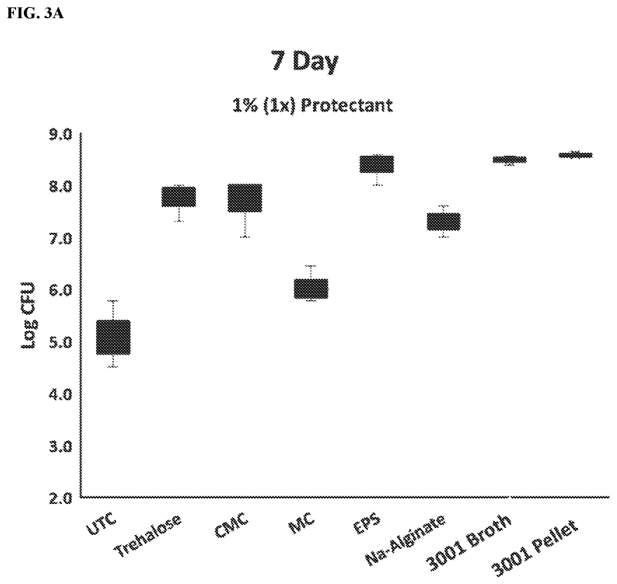

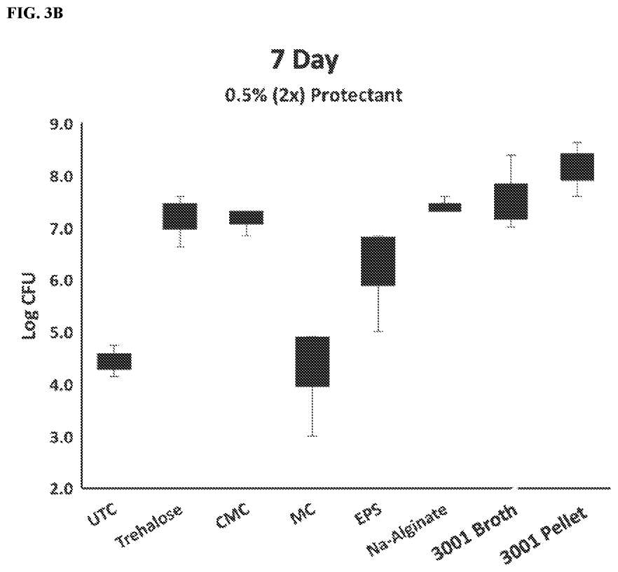

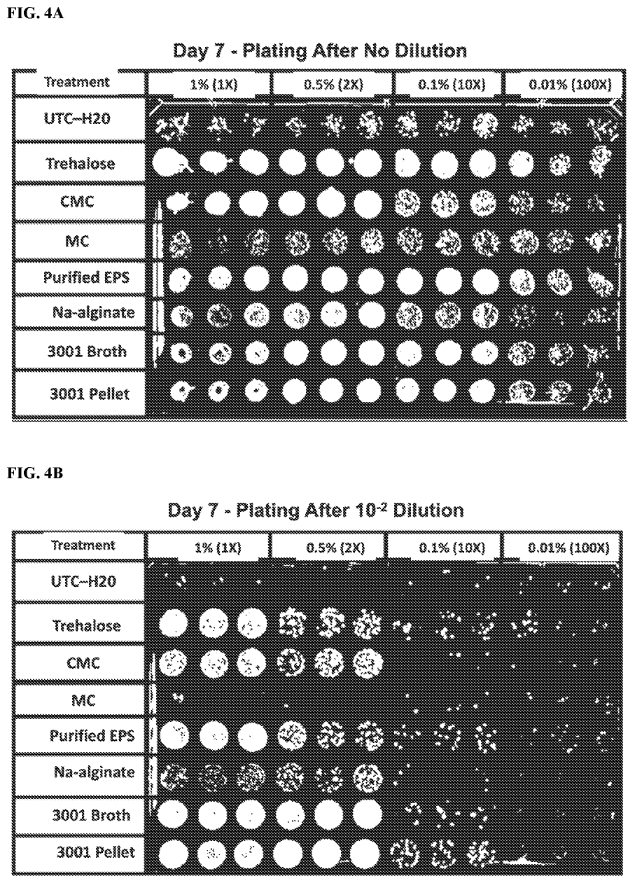

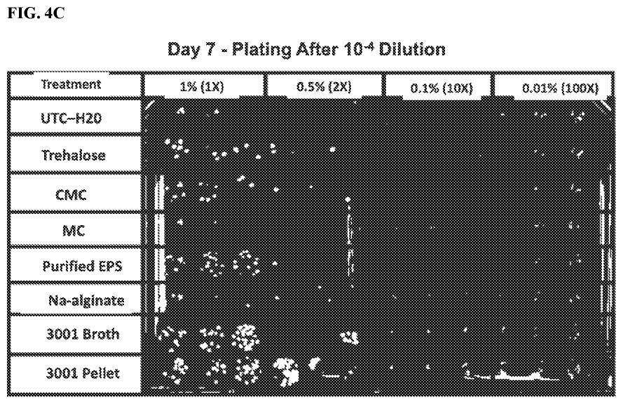

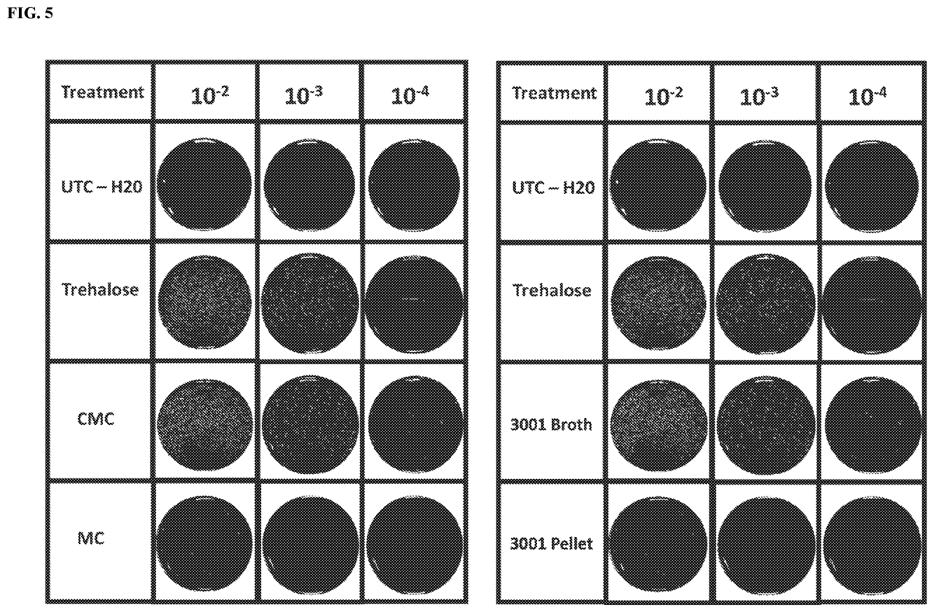

Viability results with the Kosakonia sp. cells after 7 days of desiccation stress are presented in FIGS. 3A and 3B with the corresponding representative plates shown in FIGS. 4A, 4B, and 4C. The Kosakonia sp. cell cultures after 7 days of desiccation stress were also plated onto larger agar plates (see FIG. 5) to confirm the results presented in in FIGS. 3A and 3B.

Trehalose, carboxymethylcellulose, and sodium alginate but not methylcellulose demonstrated a protective effect on the Kosakonia sp. cells similar to that observed with extracellular polymeric substance from Parachlorella kessleri Accession No. NCMA 202103001, Parachlorella kessleri Accession No. NCMA 202103001 whole broth, and Parachlorella kessleri Accession No. NCMA 202103001 cell pellet after centrifugation. The extracellular polymeric substance from Parachlorella kessleri Accession No. NCMA 202103001 (“EPS”) has been described in U.S. Patent Application No. 63/228,585, which is hereby incorporated by reference. The protective effect observed with these agents was consistent after 5 days of desiccation stress and after 7 days of desiccation stress (see FIGS. 1A, 1B, 3A, and 3B).

### Example 2. Effects of EPS and EPS-Related Chemical Compounds on the Desiccation Resistance of a Co-Culture of Gram-Negative Kosakonia pseudosacchari Strain JM-387 and Pseudomonas aylmerense Strain S1E40

The experiment described in Example 1 was repeated with a co-culture of Gram-negative Kosakonia pseudosacchari strain JM-387 and Pseudomonas aylmerense strain 51E40. These strains are described in Kampfer, P. et al., (2015). Kosakonia pseudosacchari sp. nov., an endophyte of Zea mays. Systematic and Applied Microbiology. 39. 10.1016/j.syapm.2015.09.004; and Tchagang, C. et al., (2018). Diversity of bacteria associated with corn roots inoculated with Canadian woodland soils, and description of Pseudomonas aylmerense sp. nov. Heliyon. 4. e00761, respectively. The protectant agents were mixed with the liquid co-cultures undiluted (i.e., at a 1× dilution) for whole broth and cell pellets or at a concentration of 1% (i.e., 1 g/100 mL) for all other agents.

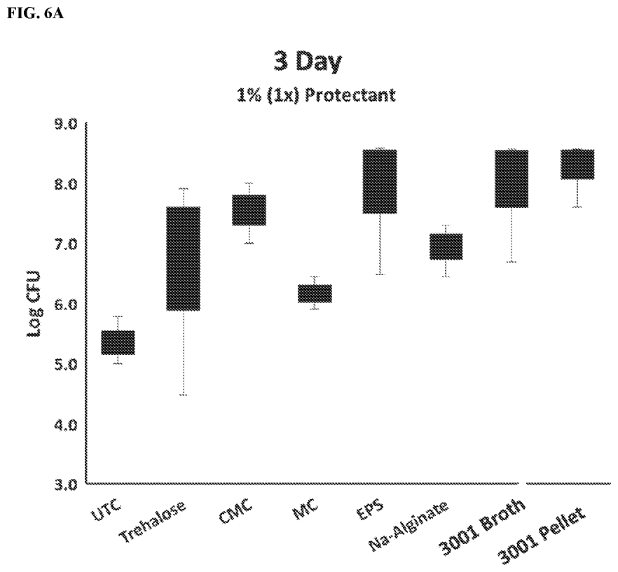

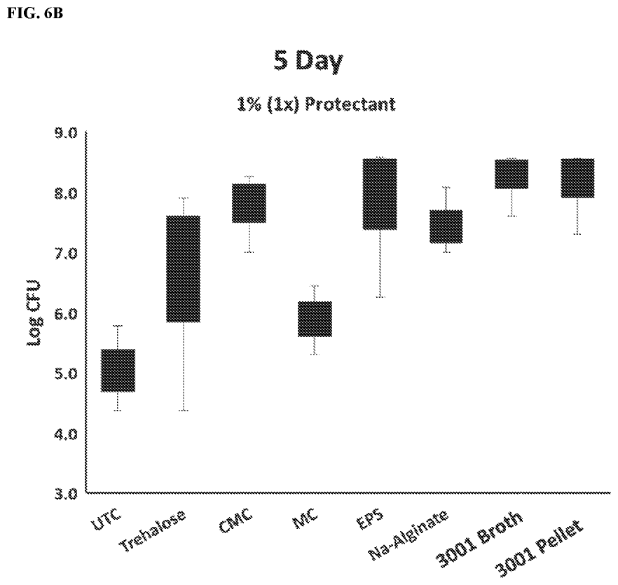

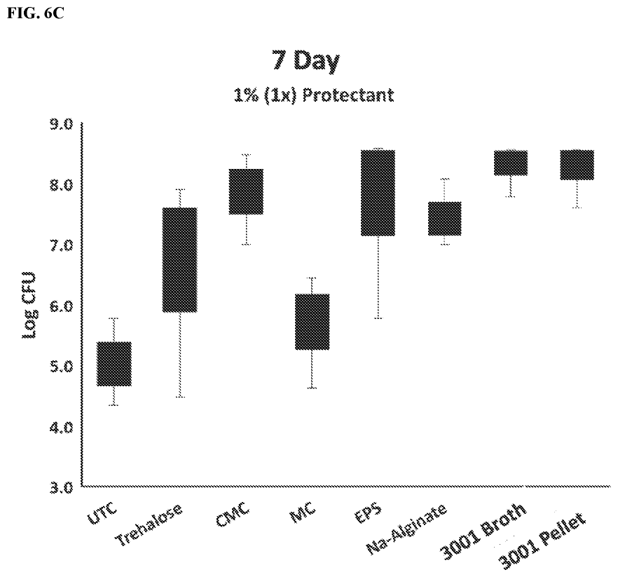

Viability results with the Kosakonia pseudosacchari strain JM-387 cells and Pseudomonas aylmerense strain S1E40 cells after 3 days, 5 days, and 7 days of desiccation stress are presented in FIGS. 6A, 6B, and 6C, respectively. Trehalose, carboxymethylcellulose, and sodium alginate again demonstrated a protective effect on the Gram-negative bacterial cells similar to that observed with extracellular polymeric substance from Parachlorella kessleri Accession No. NCMA 202103001, Parachlorella kessleri Accession No. NCMA 202103001 whole broth, and Parachlorella kessleri Accession No. NCMA 202103001 cell pellet after centrifugation.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present invention is not entitled to antedate such publication by virtue of prior invention.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

What is claimed is:

1. An agricultural composition comprising:
a) plant growth promoting Gram-negative bacteria;
b) a desiccation protectant selected from the group consisting of:
a carboxyalkylcellulose or derivative or salt thereof,
a hydroxyalkylcellulose or derivative or salt thereof,
an alginate or derivative or salt thereof,
trehalose or a derivative or salt thereof;
tamarind seed gum, locust bean gum, xanthan gum, tara gum, guar gum, pectin, pullulan, psyllium seed gum, and carrageenan; and
combinations thereof; and
c) an agriculturally acceptable carrier.

2. The agricultural composition of claim 1, wherein the carboxyalkylcellulose or derivative thereof is selected from the group consisting of: carboxymethylcellulose, hydroxyethylcarboxymethylcellulose, hydroxypropylcarboxymethylcellulose, methoxyethylcarboxymethylcellulose, ethoxyethylcarboxymethylcellulose, diethylaminocarboxymethylcellulose, and combinations thereof.

3. The agricultural composition of claim 1, wherein the hydroxyalkylcellulose or derivative thereof is selected from the group consisting of: hydroxymethylcellulose, hydroxyethylcellulose, hydroxyethyl methyl cellulose, hydroxypropylcellulose, hydroxybutylcellulose, hydroxypropyl methyl cellulose, methylhydroxyethylcellulose, methylhydroxypropylcellulose, ethyl hydroxyethyl cellulose, carboxymethylhydroxyethylcellulose, and combinations thereof.

4. The agricultural composition of claim 1, wherein the alginate or derivative thereof is selected from the group consisting of: alginic acid, sodium alginate, ammonium alginate, calcium alginate, magnesium alginate, propylene glycol alginate, and combinations thereof.

5. The agricultural composition of claim 1, wherein the trehalose or derivative thereof is trehalose or trehalose choline chloride (TCH).

6. The agricultural composition of claim 1, wherein the plant growth promoting Gram-negative bacteria belong to a genus selected from the group consisting of: Pseudomonas, Burkholderia, Stenotrophomonas, Rhizobium, Bradyrhizobium, Sinorhizobium, Azospirillum, Herbaspirillum, Lysobacter, Pantoea, Azotobacter, Enterobacter, Klebsiella, Kosakonia, Rahnella, Sphingomonas, Massilia, Gluconacetobacter, Acetobacter, Asaia, Komagataeibacter, Nguyenibacter, Swaminathania, Janthinobacterium, Duganella, Methylobacterium, Flavobacterium, Serratia, Variovorax, and combinations thereof.

7. The agricultural composition of claim 1, wherein the plant growth promoting Gram-negative bacteria are present in the agricultural composition as an isolated biologically pure culture.

8. The agricultural composition of claim 1, further comprising extracellular polymeric substance (EPS), biomass, or a combination thereof produced by microalgae.

9. The agricultural composition of claim 8, wherein the biomass is a whole broth culture or a cell pellet of the microalgae.

10. The agricultural composition of claim 8, wherein the extracellular polymeric substance comprises an exopolysaccharide.

11. The agricultural composition of claim 1, wherein the agricultural composition is formulated as a seed treatment.

12. The agricultural composition of claim 1, wherein the agricultural composition is formulated for foliar application or in-furrow application.

13. An agricultural composition comprising:
a) plant growth promoting Gram-negative bacteria;
b) a carboxyalkylcellulose or derivative thereof selected from the group consisting of: carboxymethylcellulose, hydroxyethylcarboxymethylcellulose, hydroxypropylcarboxymethylcellulose, methoxyethylcarboxymethylcellulose, ethoxyethylcarboxymethylcellulose, diethylaminocarboxymethylcellulose, and combinations thereof; and
c) an agriculturally acceptable carrier.

14. The agricultural composition of claim 13, wherein the carboxyalkylcellulose or derivative thereof is carboxymethylcellulose.

15. A plant propagation material treated with the agricultural composition of claim 1.

16. A method of increasing resistance to desiccation in plant growth promoting Gram-negative bacteria, the method comprising adding a desiccation protectant to the plant growth promoting Gram-negative bacteria,
wherein the desiccation protectant is selected from the group consisting of: a carboxyalkylcellulose or derivative or salt thereof, a hydroxyalkylcellulose or derivative or salt thereof, an alginate or derivative or salt thereof, trehalose or a derivative or salt thereof; and combinations thereof.

17. (canceled)

18. (canceled)

19. (canceled)

20. The method of claim 16, wherein the trehalose or derivative thereof is trehalose or trehalose choline chloride (TCH).

21. (canceled)

22. The method of claim 16, further comprising adding to the plant growth promoting Gram-negative bacteria an extracellular polymeric substance (EPS), biomass, or a combination thereof produced by microalgae.

23. The method of claim 22, wherein the biomass is a whole broth culture or a cell pellet of the microalgae.

24. The method of claim 22, wherein the extracellular polymeric substance comprises an exopolysaccharide.
